(19) United States
(12) Patent Application Publication
(10) Pub. No.: US 2014/0038755 A1
(43) Pub. Date: Feb. 6, 2014

(54) CONTROL SYSTEM FOR BELT TYPE CONTINUOUSLY VARIABLE TRANSMISSION

(71) Applicants: Akira Ijichi, Susono-shi (JP); Toshinari Sano, Gotemba-shi (JP); Masafumi Yamamoto, Susono-shi (JP); Tatsuya Saito, Susono-shi (JP)

(72) Inventors: Akira Ijichi, Susono-shi (JP); Toshinari Sano, Gotemba-shi (JP); Masafumi Yamamoto, Susono-shi (JP); Tatsuya Saito, Susono-shi (JP)

(73) Assignee: TOYOTA JIDOSHA KABUSHIKI KAISHA, Toyota-shi, Aichi (JP)

(21) Appl. No.: 13/375,435

(22) PCT Filed: Apr. 20, 2011
(86) PCT No.: PCT/JP11/59685

§ 371 Date: Nov. 30, 2011

(51) Int. Cl. F16H 9/12

(52) U.S. Cl. CPC F16H 9/125
USPC 474/11

(57) ABSTRACT

A control system for a belt-type continuously variable transmission capable of preventing deterioration in fuel economy.

A friction coefficient μ2 in a radially outer region of the tapered face of the driven pulley 7 is smaller than a friction coefficient μ1 in a radially inner region, and the control system comprises a speed change region setting means that increases frequency of carrying out a speed change operation within the radially inner region in case the energy saving mode is selected.

### TECHNICAL FIELD

The present invention relates to a control system for a belt-type continuously variable transmission for transmitting power through a driving belt applied between a drive pulley and a driven pulley, while varying a speed change ratio steplessly by varying a running radius of the driving belt continuously.

### BACKGROUND ART

The belt-type continuously variable transmission of this kind is configured to transmit the power by a frictional force between the driving belt and the pulleys holding the driving belt therebetween. The belt-type continuously variable transmission thus structured is configured to change the speed change ratio thereof continuously by varying a groove width between a drive pulley and a driven pulley thereby varying the running radius of the driving belt. The driving belt can be categorized into a metal band formed by fastening a plurality of metal pieces called an element or a block by a steel belt, and a nonmetallic belt formed mainly of rubber or resin. In case of using the nonmetallic belt in the belt-type continuously variable transmission, the resin or the rubber is contacted with the pulleys and a contact point between the belt and the pulley is not lubricated. Therefore, a friction coefficient of the nonmetallic belt is larger than that of the metal band. For this reason, in case of using the nonmetallic belt in the belt-type continuously variable transmission, it is difficult to carry out a speed change operation or it is impossible to carry out the speed change operation under the situation in which a rotational speeds of the pulleys are low or the pulleys are not rotated.

For example, Japanese Patent Laid-Open No. 2004-116536 discloses a belt-type continuously variable transmission using such a nonmetallic belt. According to the teachings of Japanese Patent Laid-Open No. 2004-116536, a nonmetallic belt is applied between a drive pulley and a driven pulley, and the continuously variable transmission is provided with a transmission motor for changing a groove between the pulleys. Specifically, a continuous current motor (i.e., a DC motor) is used as the transmission motor, and rotation property thereof such as a rotational speed and a rotational efficiency is changed depending on a rotational direction thereof. That is, the rotational speed of the transmission motor of the case of increasing the speed change ratio of the continuously variable transmission is faster than the rotational speed of the case of reducing the speed change ratio of the continuously variable transmission. In other words, the transmission motor is configured to accelerate a deceleration. Therefore, in case a vehicle running at high speed is decelerated abruptly, the speed change ratio of the continuously variable transmission taught by Japanese Patent Laid-Open No. 2004-116536 can be returned to the low speed side quickly. For this reason, according to the teachings of Japanese Patent Laid-Open No. 2004-116536, restartability of the vehicle can be improved.

As described, the friction coefficient of the nonmetallic belt is larger than that of the metal belt. Therefore, in case of using the nonmetallic belt in the belt-type continuously variable transmission, the nonmetallic belt will not slip in the groove of the pulleys as easy as the metal belt. For this reason, the speed change ratio of the continuously variable transmission thus using the nonmetallic belt is basically changed while rotating the pulleys. That is, the speed change ratio of the continuously variable transmission of this kind is changed depending on the rotational speed. Therefore, according to the teachings of Japanese Patent Laid-Open No. 2004-116536, the transmission motor is configured to accelerate a decelerating operation thereby returning the speed change ratio of the continuously variable transmission to the low speed side quickly in case of abruptly stopping the vehicle running at high speed. However, energy has to be consumed excessively to increase the rotational speed of the transmission motor. As a result, fuel economy of the vehicle may be degraded.

### DISCLOSURE OF THE INVENTION

The present invention has been conceived noting the technical problems thus far described, and an object of the present invention is to provide a control system for a belt-type continuously variable transmission configured to prevent a deterioration in fuel economy.

In order to achieve the above-mentioned object, according to the present invention, there is provided a control system for a belt-type continuously variable transmission. The control system of the present invention is applied to the belt-type continuously variable transmission, comprising: a drive pulley and a driven pulley, each of which is formed by a fixed sheave integrated with a rotary shaft and a movable sheave allowed to moved in an axial direction; and a driving belt interposed between tapered faces of the fixed sheave and the movable sheaves being opposed to each other. The belt-type continuously variable transmission is configured to change a torque of a prime mover by varying a speed change ratio continuously while moving the movable sheave in an axial direction. Meanwhile, the control system is configured to select a drive mode of the vehicle from a plurality of drive modes including an energy saving mode for reducing an energy consumption of the prime mover, and to control a speed change operation on the basis of any of the selected drive mode. According to the present invention, a friction coefficient in a radially outer region of the tapered face of the driven pulley is smaller than that in a radially inner region of the tapered face of the driven pulley, and the control system comprises a speed change region setting means that increases frequency of carrying out a speed change operation within said radially inner region in case the energy saving mode is selected.

Specifically, according to the present invention, the speed change region setting means includes an inhibiting means that increases frequency of carrying out a speed change operation within the radially inner region, by inhibiting a speed change operation in said radially outer region.

The aforementioned drive mode includes a normal mode for a case of running the vehicle normally, and the speed change region setting means includes a means that increases frequency of carrying out a speed change operation within said radially inner region in case the energy saving mode is selected, by restricting the region of the tapered face used to change the speed change ratio within the region used to set the speed change ratio smaller than that set in the region used to change the speed change ratio under the normal mode.

More specifically the speed change region setting means includes a means that carries out the speed change operation only within said radially inner region.

According to the present invention, the control system for a belt-type continuously variable transmission further comprises: a drive mode judging means that judges whether or not the energy saving mode is selected; and a torque demand judging means that judges whether or not the prime mover is demanded to increase the torque thereof. Specifically, the control mode judging means includes a means adapted to judge that the energy saving mode is not selected even if the energy saving mode is selected, in case the drive mode judging means judges that the energy saving mode is selected, and the torque demand judging means judges that the prime mover is demanded to increase the torque thereof.

In addition, the torque demand judging means includes a means that judges whether or not the prime mover is demanded to increase the torque thereof, on the basis of a fact that a drive demand of the vehicle is increased, or a fact that the vehicle is climbing a hill.

According to the present invention, the aforementioned radially outer region includes a region where the driving belt is situated to set a speed change ratio possible to start the stopping vehicle.

Specifically, the driving belt used in the present invention is a nonmetallic combined belt comprising a plurality of metal pieces withstanding a pressure from the tapered faces of the sheaves forming a belt groove, and a resin band fastening the metal pieces in a circular manner.

Thus, according to the present invention, the frictional coefficient in the radially outer region of the tapered face of the driven pulley is smaller than that in the radially inner region. In addition, the control system comprises the speed change region setting means that increases frequency of carrying out a speed change operation within the radially inner region of the tapered face of the driven pulley, in case the energy saving mode is selected. Therefore, in case the energy saving mode is selected, the speed change operation is carried out mainly within the radially inner region of the tapered face of the driven pulley at which the friction coefficient is relatively large. For this reason, a pushing force applied to the movable sheave of the driven pulley can be reduced and power transmission efficiency can be improved, in comparison with a case of carrying out a speed change operation within the radially outer region. In addition, energy consumption of the prime mover can be reduced. Further, since the frictional coefficient in said radially outer region is thus smaller than that in said radially inner region, the driving belt in the belt groove of the driven pulley is allowed to slide in the radial direction by merely changing a groove width of the driven pulley, even in case the rotational speed of the driven pulley is low or in case the driven pulley is not rotated. That is, a sliding speed change can be carried out. This means that the speed change ratio can be changed irrespective of the rotation of the driven pulley. In addition, since the speed change operation can be carried out while sliding the driving belt in the radially outer region of the belt groove of the driven pulley, a speed changing rate in a direction to increase the speed change ratio can be quickened. That is, the driving belt can be returned smoothly to the radially outer region of the belt groove of the driven pulley even in case of decelerating or stopping the vehicle abruptly.

As described, the speed change region setting means includes the inhibiting means that inhibits a speed change operation in the radially outer region of the belt groove. Therefore, according to the present invention, the frequency of carrying out a speed change operation within the radially inner region of the tapered face of the driven pulley can be increased. As a result, the energy consumption of the prime mover can be further reduced.

In addition, the speed change region setting means includes the means adapted to restrict the region of the tapered face used to change the speed change ratio in case the energy saving mode is selected, within the region used to set the speed change ratio smaller than that set by the region used to change the speed change ratio under the normal mode. Therefore, according to the present invention, the frequency of carrying out a speed change operation within the radially inner region of the tapered face of the driven pulley can be increased.

In addition, the speed change region setting means includes the means that carries out the speed change operation only within the radially inner region of the tapered face of the driven pulley. Therefore, according to the present invention, the speed change operation can be carried out using only the radially inner region of the tapered face of the driven pulley in case the energy saving mode is selected. For this reason, the fuel consumption of the prime mover can be further reduced.

As also described, the control system according to the present invention further comprises: the drive mode judging means that judges whether or not the energy saving mode is selected; and the torque demand judging means that judges whether or not the prime mover is demanded to increase the torque thereof. In addition, the control mode judging means is adapted to judge that the energy saving mode is not selected even if the energy saving mode is actually selected, in case the drive mode judging means judges that the energy saving mode is selected, and the torque demand judging means judges that the prime mover is demanded to increase the torque thereof. That is, in case the torque demand judging means judges that the prime mover is demanded to increase the torque, the drive mode judging means judges that the energy saving mode is not selected. In this case, therefore, the prime mover is allowed to increase the output torque thereof. That is, the driving force can be increased according to the driving condition of the vehicle.

The torque demand judging means further includes a means that judges whether or not the prime mover is demanded to increase the torque thereof, on the basis of the fact the vehicle is climbing up a hill. Therefore, in case the vehicle is climbing up the hill so that the torque demand judging means judges that the prime mover is demanded to increase the torque, the prime mover is allowed to increase the output torque thereof. For this reason, a climbing performance of the vehicle can be improved.

As also described, the aforementioned radially outer region of the tapered face of the driven pulley includes a region where the driving belt is situated to set a speed change ratio possible to start the stopping vehicle. Therefore, the driving belt can be returned smoothly to the region for setting the speed change ratio to start the vehicle even in case the speed change ratio is increased abruptly by decelerating or stopping the vehicle abruptly. For this reason, the vehicle can be accelerated smoothly even after the abrupt deceleration, or restarted smoothly even after stopped.

In addition to the above-explained advantages, according to the present invention, the speed change can be achieved by sliding the driving belt in the radial direction even if the nonmetallic driving belt is used in the continuously variable transmission. In other words, the speed change can be achieved regardless of the rotational speed of the pulleys. Therefore, even if the nonmetallic driving belt is thus used, the speed change rate of the continuously variable transmission in the direction to increase the speed change ratio can be quickened while reducing the pushing force being applied to the movable sheave. For this reason, durability of the nonmetallic driving belt as well as the continuously variable transmission can be improved. Further, as described, the driving belt can be returned quickly to the region for setting the speed change ratio possible to start the vehicle in case of decelerating or stopping the vehicle abruptly. Thus, the speed change ratio required to accelerate or start the vehicle can be set promptly even after the vehicle is decelerated or stopped abruptly.

### BRIEF DESCRIPTION OF THE DRAWINGS

FIG. 1 is a flowchart explaining a control example of the belt-type continuously variable transmission according to the present invention.

FIG. 2 is a map used to calculate a theoretical target input speed in case an economy mode is selected.

FIG. 3 is a map used to calculate the theoretical target input speed in case a normal mode is selected.

FIG. 4 is a block diagram briefly explaining a procedure of the speed change control.

FIG. 5 is a flowchart explaining another control example of the belt-type continuously variable transmission according to the present invention.

FIG. 6 is a view showing an example of the tapered face of the driven pulley.

FIG. 7 is a view showing the belt-type continuously variable transmission according to the present invention under the situation in which the speed change ratio thereof is decreased.

FIG. 8 is a view showing the belt-type continuously variable transmission according to the present invention under the situation in which the speed change ratio thereof is increased.

FIG. 9 is a graph schematically showing a relation between the speed change ratio of the continuously variable transmission and the friction coefficient of the driven pulley.

FIG. 10 is a view schematically showing an example of a structure of a vehicle to which the present invention is applied.

### BEST MODE FOR CARRYING OUT THE INVENTION

The present invention relates to a control system for a belt-type continuously variable transmission configured to change a speed change ratio continuously by varying a running radius of a driving belt applied to a drive pulley and a driven pulley. The control system of this kind is configured to select a drive mode from a plurality of drive modes, and a speed change ratio of the continuously variable transmission is changed in different patterns depending on the selected drive mode. Therefore, a driving force and acceleration of the vehicle is changed depending on the selected drive mode. That is, an energy consumption of the prime mover for running the vehicle is governed by the selected drive mode.

First of all, a structure of the belt-type continuously variable transmission will be explained hereinafter. In the belt-type continuously variable transmission, a running radius of the driving belt is changed by changing a width of a V-shaped groove (as will be called a belt groove hereinafter) formed between sheaves of a pulley. Specifically, each of drive and driven pulleys is formed by a pair of sheaves, and inner faces of those sheaves opposed to each other are individually tapered to form the belt groove between those sheaves. One of those sheaves is integrated with a rotary shaft (i.e., a pulley shaft) to serve as a fixed sheave, and the other sheave is allowed to reciprocate on the rotary shaft to serve as a movable sheave.

For example, a metal belt (or a wet-type belt) is formed by fastening a plurality of metal pieces called an element or a block by a steel belt in a circular manner. Meanwhile, a nonmetallic combined belt (or a dry-type belt) is formed by combining a nonmetallic belt such as a resin belt and rubber belt with a plurality of metal pieces to enhance a transmission torque capacity thereof. According to the present invention, both of the metal belt and the nonmetallic belt can be used as the driving belt of the continuously variable transmission.

According to the present invention, a friction coefficient of the tapered face of each sheave of the driven pulley is differentiated between a radially outer side and radially inner side. Specifically, in the driven pulley, the friction coefficient in the radially outer region of the tapered face of each sheave is reduced to be smaller than that in the radially inner region. Therefore, in the driven pulley, a friction between the driving belt and each of the tapered face is smaller in the radially outer region of the belt groove in comparison with that in the radially inner region of the belt groove. For this purpose, the radially outer region of the tapered face of each sheave of the driven pulley is made of synthetic resin, and the radially inner region of the tapered face of each sheave of the driven pulley is made of metal material. Alternatively, the friction coefficient of the tapered face can be differentiated by forming a plurality of slits radially on the tapered face, or by increasing roughness of the tapered face from the radially outer side toward the radially inner side gradually or stepwise. Specifically, in the driven pulley, the friction coefficient of the radially outer region of the tapered face of each sheave is reduced to the extent of allowing the driving belt to slide thereon in the radial direction by merely moving the movable sheave, even under the situation in which the driven pulley is rotated at low speed or stopped.

In case of forming the radially outer region of the tapered face using the synthetic resin, the friction coefficient thereof may also be differentiated between a circumferential direction and the radial direction. For this purpose, fiber-reinforced composite material composed mainly of reinforcing fiber and matrix resin may be used to form the radially outer region of the tapered face of each sheave of the driven pulley, and the fiber of the composite material is oriented substantially in the circumferential direction of the pulley. Consequently, the friction coefficient of the tapered face in the radial direction can be reduced while maintaining sufficient friction coefficient in the circumferential direction.

Thus, according to the belt-type continuously variable transmission of the present invention, the driven pulley is configured to allow the driving belt to slide radially in the outer regions of the belt groove formed by the sheaves according to a change in the groove width, and the outer regions of the belt groove of the driven pulley includes a region where the driving belt is situated in case of setting the speed change ratio possible to start the stopping vehicle. In addition, the frictional coefficient of the radially outer region of the tapered face can be changed by a conventional method such as a coating, an etching, a shotblasting and etc.

Meanwhile, a driving pulley may be a conventional one configured to reduce the running radius of the driving belt in case of decelerating or stopping the vehicle, for the purpose of increasing the speed change ratio of the belt-type continuously variable transmission to restart the stopped vehicle or accelerate the decelerated vehicle.

The belt-type continuously variable transmission is provided with an electronic control unit adapted to control the speed change operation electrically. For this purpose, the electronic control unit is configured to select the drive mode from a plurality of drive modes including an energy saving mode for controlling the speed change ratio of the belt-type continuously variable transmission in a manner to reduce an energy consumption of the prime mover generating a driving force of the vehicle.

As described, in the driven pulley, the friction coefficient of the radially outer region of the tapered faces of the belt groove is reduced. Therefore, in case of changing the speed change ratio using the radially outer region of the belt groove of the drive pulley, it is necessary to increase a pushing force for pushing the movable sheave toward the fixed sheave. That is, in case of carrying out a speed change operation using the radially outer region of the belt groove of the movable sheave under the energy saving mode, the energy consumption rate may be degraded. In order to avoid such a disadvantage, according to the present invention, the control system is configured to increase a frequency to use the radially inner region of the belt groove of the driven pulley where the friction coefficient is relatively large, in case of carrying out the speed change operation under the situation in which the energy saving mode is selected.

Thus, according to the present invention, only the radially inner region of the belt groove is used in the in the driven pulley in most of the situation to carry out the speed change operation under the energy saving mode. Therefore, a required pushing force for pushing the movable sheave to change the speed change ratio can be reduced so that the fuel economy of the prime mover can be improved.

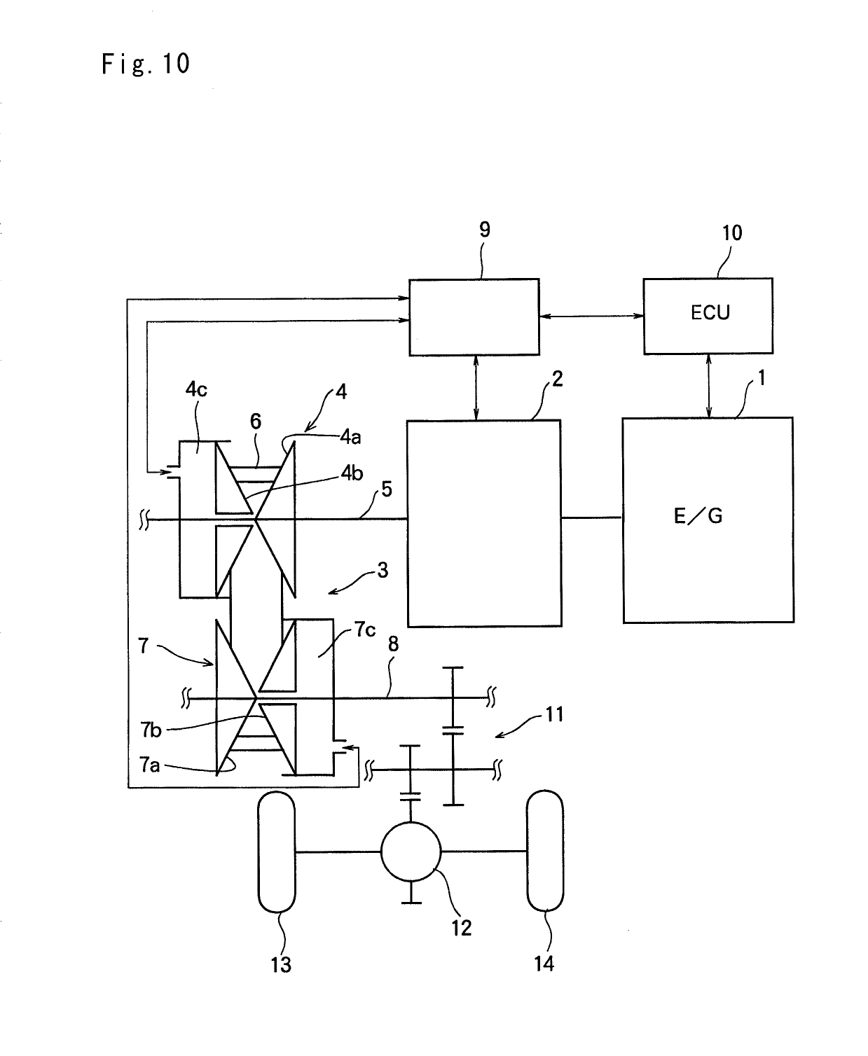

Next, an example of a structure of the vehicle to which the present invention is applied will be explained with reference to FIG. 10. In the example shown in FIG. 10, an engine 1 is used as the prime mover. However, a known prime mover such as an internal combustion engine, an electric motor, a combination of the engine and the motor and so on may also be used as the prime mover. An output side of the engine 1 is connected with a transmission mechanism 2 comprising a torque converter and a torque reversing mechanism. Although not especially shown in FIG. 10, a conventional torque converter having a lockup clutch can be used in this example. Specifically, the torque reversing mechanism is configured to reverse a rotational direction of the torque thereby switching a traveling direction of the vehicle between a forward direction and a backward direction. For example, a torque reversing mechanism composed mainly of a double-pinion type planetary gear mechanism may be used.

A belt-type continuously variable transmission 3 is arranged on an output side of the transmission mechanism 2. Specifically, the belt-type continuously variable transmission 3 comprises: a drive pulley 4; a driven pulley 7; and a driving belt 6 applied to those pulleys 4 and 7. An output shaft of the transmission mechanism 2 is connected with a pulley shaft 5 of the drive pulley 4 in a power transmittable manner. The drive pulley 4 is formed by a pair of fixed sheave 4a and movable sheave 4b, and the driven pulley 7 is formed by a pair of fixed sheave 7a and movable sheave 7b. Each inner face of the fixed sheave 4a and the movable sheave 4b being opposed to each other is tapered, and each inner face of the fixed sheave 7a and the movable sheave 7b being opposed to each other is also tapered. Therefore, a belt groove is formed in the drive pulley 4 between the tapered inner faces of the sheaves 4a and 4b, and a belt groove is formed in the driven pulley 7 between those tapered inner faces of the sheaves 7a and 7b. In the drive pulley 4 and the driven pulley 7 thus structured, a running radius of the driving belt 6 interposed between the sheaves 4a and 4b and between the shaves 7a and 7b is individually varied by changing a width of the belt groove of each pulley 4 and 7.

For example, a metal belt (or a wet-type belt) formed by fastening a plurality of metal pieces called an element or a block by a steel band in a circular manner may be used as the driving belt 6. Alternatively, a nonmetallic combined belt (or a dry-type belt) formed by combining a nonmetallic belt such as a resin band and rubber band with a plurality of metal blocks to enhance a transmission torque capacity thereof may also be used as the driving belt 6. In the example to be explained hereinafter, the nonmetallic combined belt is used as the driving belt 6. Although not especially shown in the accompanying figures, the driving belt 6 is configured to withstand lateral pressure from the belt grooves of the pulleys 4 and 7 by the plurality of blocks contacted thereto, and those metal blocks are fastened in a circular manner by the resin band.

Specifically, the block is a metal plate member made of steel, aluminum alloy etc. and the block is covered with a resin. Alternatively, the nonmetallic combined belt 6 may also be formed by combining blocks made of high-strength synthetic resin integrally with a resin band. In addition, both width end sides of the block are tapered to be contacted with the belt grooves of the pulleys 4 and 7.

In the example shown in FIG. 10, a positional relation between the fixed sheave 4a and the movable sheave 4b is opposite to that between the fixed sheave 7a and the movable sheave 7b. However, fundamental structures of the drive pulley 4 and the driven pulley 7 are identical to each other. Hereinafter, the structures of the drive pulley 4 and the driven pulley 7 will be explained in more details. The fixed sheave 4a is integrated with the pulley shaft 5, and the fixed sheave 7a is integrated with a pulley shaft 8. As described, the pulley shaft 5 is connected with the output shaft of the engine 1 in a power transmittable manner through the transmission mechanism 2. Therefore, a power generated by the engine 1 is inputted to the pulley shaft 5. In the drive pulley 4, the pulley shaft 5 extends from the fixed sheave 4a toward the movable sheave 4b, and the movable sheave 4b is fitted onto the pulley shaft 5 while being allowed to reciprocate in the axial direction of the pulley shaft 5. Therefore, the tapered faces of the fixed sheave 4a and the movable sheave 4b are opposed to each other.

Likewise, in the driven pulley 5, the pulley shaft 8 extends from the fixed sheave 7a toward the movable sheave 7b, and the movable sheave 7b is fitted onto the pulley shaft 8 while being allowed to reciprocate in the axial direction of the pulley shaft 8. Therefore, the tapered faces of the fixed sheave 7a and the movable sheave 7b are opposed to each other.

In order to apply a pushing force to the movable shave 4b toward the fixed sheave 4a thereby clamping the driving belt 6 therebetween, a hydraulic chamber 4c is arranged behind the movable sheave 4b. Likewise, in order to apply a pushing force to the movable shave 7b toward the fixed sheave 7a thereby clamping the driving belt 6 therebetween, a hydraulic chamber 7c is arranged behind the movable sheave 7b. In the belt-type continuously variable transmission 3 thus structured, the torque is transmitted between the driving belt 6 and the pulleys 4 and 7 by a frictional force. Therefore, a capacity of the belt-type continuously variable transmission 3 to transmit the torque is governed by hydraulic pressures applied to the hydraulic chambers 4c and 7c. In addition, a speed change ratio of the belt-type continuously variable transmission 3 can be changed continuously or stepwise by controlling the hydraulic pressure applied to the hydraulic chambers 4c and 7c. Specifically, the speed change ratio of the belt-type continuously variable transmission 3 is changed with reference to a map for calculating a target speed of the engine 1, a speed change ratio of the continuously variable transmission 3 and so on based on a vehicle speed according to a depression of an accelerator or an opening degree of a throttle valve. For example, a speed change operation of the continuously variable transmission 3 is carried out by: calculating a target output of the engine 1 on the basis of the opening degree of the throttle valve or the vehicle speed; calculating a target engine speed on the basis of the calculated target output with reference to an optimum fuel economy curve; and thereafter changing the speed change ratio of the continuously variable transmission 3 to a ratio which can achieve the calculated target engine speed.

As described, the control system according to the present invention is capable of selecting the drive mode from a fuel saving mode (i.e., economy mode) for reducing fuel consumption, a power mode for increasing a driving force or enhancing acceleration; and a normal mode for carrying out a speed change operation in a normal pattern. Specifically, under the economy mode, an upshifting is carried out at relatively low speed, and the speed change ratio is kept to a relatively small ratio even in case the vehicle is driven at low speed. To the contrary, under the power mode, the upshifting is carried out at relatively high speed, and the speed change ratio is kept to a relatively large ratio even in case the vehicle is driven at high speed. Those speed change controls are carried out by switching the speed change map while correcting the drive demand or the calculated speed change ratio.

In order to control the hydraulic pressure to be applied to the hydraulic chambers 4c and 7c, the vehicle shown in FIG. 10 is provided with a hydraulic control unit 9. Specifically, the hydraulic control unit 9 is configured to be controlled electrically thereby applying a control pressure to the hydraulic chambers 4c and 7c. For this purpose, although not shown in FIG. 10, the hydraulic control unit 9 is provided with an electromagnetic feeding valve adapted to feed operating oil from a hydraulic source to the hydraulic chambers 4c and 7c, and an electromagnetic drain valve adapted to drain the operating oil from the hydraulic chambers 4c and 7c. Thus, the hydraulic pressure applied to the hydraulic chambers 4c and 7c can be controlled electrically by controlling those electromagnetic valves of the hydraulic control unit 9.

In order to control the hydraulic control unit 9 electrically, the vehicle shown in FIG. 10 is further provided with an electronic control unit (abbreviated as ECU) 10, and the above-explained maps are stored in the ECU 10. For example, signals from a vehicle speed detection sensor, an acceleration detection sensor, an acceleration demand detection sensor such as an accelerator sensor, a throttle sensor for detecting an opening degree of the throttle valve controlling air intake of the engine 1, a mode selecting switch for switching a drive mode of the vehicle and so on are inputted to the ECU 10. In addition, environmental information such as traffic information, a road gradient, a current location, a contemplated route and so on are inputted to the ECU 10 from a navigation system. Meanwhile, the ECU 10 is configured to output a control signal for controlling an opening degree of the throttle valve, a control signal for controlling an amount of fuel injection, a control signal for controlling the hydraulic control unit 9 to change the speed change ratio of the continuously variable transmission 3 and so on. Thus, the ECU 10 is configured to carry out a speed change of the belt-type continuously variable transmission 3 on the basis of the selected drive mode while controlling the speed and output torque of the engine 1.

Meanwhile, the pulley shaft 8 integrated with the driven pulley 7 is connected with a differential 12 through a counter gear unit 11. Therefore, the power is distributed to both of driving wheels 13 and 14 by the differential 12.

Although not especially shown, in order to stabilize a behavior and attitude of the vehicle, the vehicle shown in FIG. 10 is further provided with an antilock brake system (abbreviated as ABS), a traction control system, and a vehicle stability control system (abbreviated as VSC) for controlling those systems integrally. Those systems are known in the art, and adapted to stabilize the behavior of the vehicle by preventing a locking and slippage of the drive wheels 13 and 14. For this purpose, those systems are configured to control a braking force applied to the drive wheels 13 and 14 on the basis of a deviation between a vehicle speed and a wheel speed while controlling the engine torque. As described, the vehicle shown in FIG. 10 is provided with the navigation system and the mode selecting switch. Specifically, the mode selecting switch is configured to select characteristics of power, acceleration, suspension etc. of the vehicle manually. For example, the above-explained drive mode can be switched by the mode selecting switch among the energy saving mode for saving energy, the power mode for enhancing power and acceleration, and the normal mode for moderating the acceleration and suspension of the vehicle. In addition, a snow mode for controlling the drive torque in a manner to avoid a tire slip on a slippery road such as a snowy road, and a sport mode for improving the acceleration and slightly hardening the suspension can also be selected by the mode selecting switch.

Additionally, a 4-wheel-drive mechanism (4WD) configured to change a driving characteristics such as a hill-climbing ability, an acceleration, a turning ability and so on may be arranged in the vehicle shown in FIG. 10.

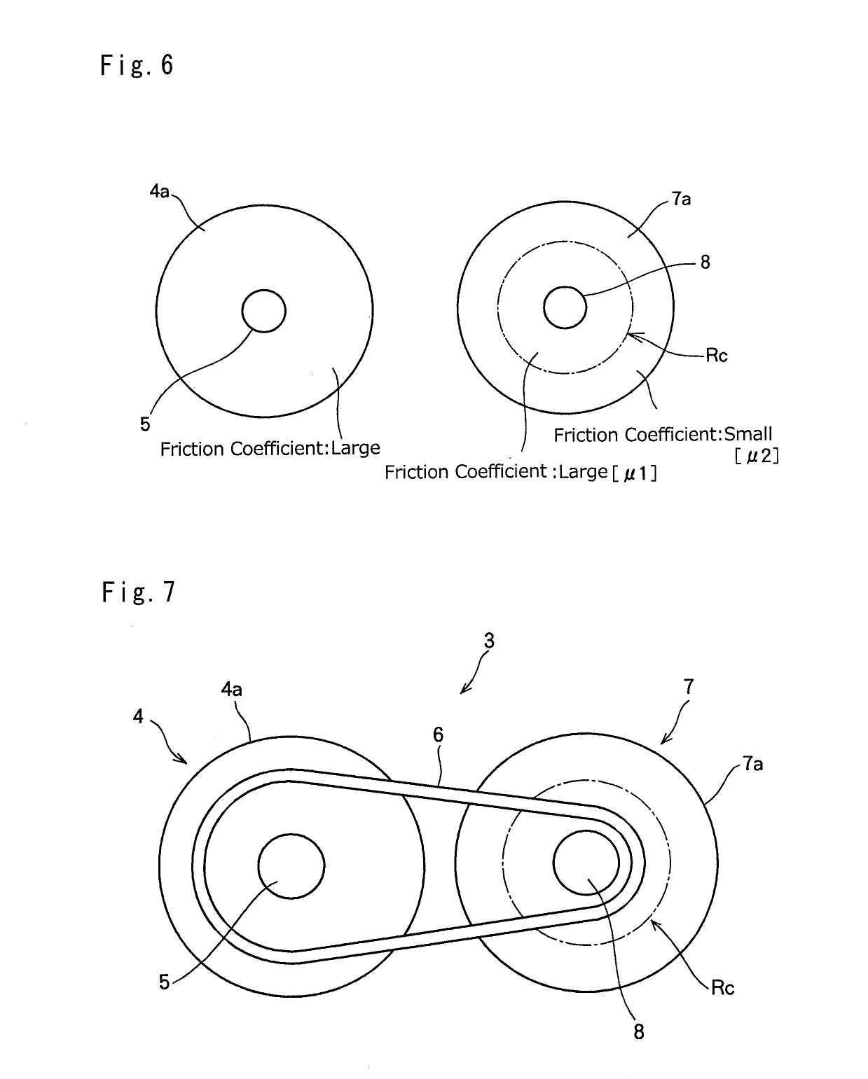

An example of a configuration of the tapered faces of the driven pulley 7 is shown in FIG. 6. In the fixed sheave 7a shown in FIG. 6, an inner face thereof is tapered, and a friction coefficient μ2 of a radially outer region of the tapered face is smaller than a friction coefficient μ1 of a radially inner region of the tapered face (μ1>μ2). For example, the friction coefficient μ2 can be reduced to be smaller than the friction coefficient μ1 by forming the radially outer region of the tapered face using synthetic resin, while forming the radially inner region of the tapered face using metal material. Alternatively, the friction coefficient μ2 can be reduced to be smaller than the friction coefficient μ1 by forming a plurality of slits radially on the tapered face, or by increasing roughness of the tapered face from the radially outer side toward the radially inner side gradually or stepwise. Consequently, friction between the driving belt 6 and the radially outer region of the tapered face can be reduced to be smaller than that between the driving belt 6 and the radially inner region of the tapered face. Specifically, the friction coefficient μ2 of the radially outer region of the tapered face is reduced to the extent of allowing the driving belt 6 to slide thereon in the radial direction by merely changing a width of the belt groove, even under the situation in which the driven pulley 7 is rotated at low speed or stopped. In addition, the frictional coefficient of the radially outer region of the tapered face can be reduced by a conventional method such as a coating, an etching, a shotblasting and etc.

In case of forming the radially outer region of the tapered face of using the synthetic resin, the friction coefficient thereof may also be differentiated between a circumferential direction and the radial direction. Specifically, fiber-reinforced composite material composed mainly of reinforcing fiber and matrix resin is used to form the radially outer region of the tapered face of each sheave of the driven pulley 7, and the fiber of the composite material is oriented substantially in the circumferential direction of the driven pulley 7. Consequently, the friction coefficient of the tapered face in the radial direction can be reduced while maintaining sufficient friction coefficient in the circumferential direction. In this case, a slippage of the driving belt 6 in the circumferential direction of the driven pulley 7 can be prevented while allowing the driving belt 6 to slide in the radial direction of the driven pulley 7 in case of changing the speed change ratio.

Thus, the driven pulley 7 is configured to allow the driving belt 6 to slide radially in the radially outer region of the belt groove formed by the shaves 7a and 7b according to a change in the width of the belt groove, and the radially outer region of the belt groove includes a region where the driving belt 6 is situated in case of setting the speed change ratio possible to start the stopping vehicle. In FIG. 6, a dashed line represents a border of radius Rc at which the friction coefficient of the tapered face of the fixed sheave 7a is changed. That is, the region in the inner circumferential side of the border Rc around the pulley shaft 8 is the above-explained radially inner region of the tapered face, and the driving belt 6 is situated in the radially inner region of the belt groove of the driven pulley 7 in case of increasing the input speed of the belt-type continuously variable transmission 3. Meanwhile, the region in the outer circumferential side of the border Rc is the above-explained radially outer region of the tapered face, and the driving belt 6 is situated in the radially outer region of the belt groove of the driven pulley 7 in case of decreasing the input speed of the belt-type continuously variable transmission 3. Here, a speed change ratio to be set in case the driving belt 6 is situated at the border Rc is called as a border ratio y c.

Next, an action of the belt type-continuously variable transmission 3 thus structured will be explained hereinafter. FIG. 7 is a view showing the belt type-continuously variable transmission 3 reducing the speed change ratio thereof. In case of reducing the speed change ratio of the belt type-continuously variable transmission 3 as shown in FIG. 7, that is, in case of increasing the input speed of the belt type-continuously variable transmission 3, the movable sheave 4b of the drive pulley 4 is pushed toward the fixed sheave 4a. As a result, a width of the belt groove of the drive pulley 4 is narrowed and the driving belt 6 held therein is thereby pushed radially outwardly, that is, a running radius of the diving belt 6 in the drive pulley 4 is thereby widened. In this situation, in the driven pulley 7, a width of the belt groove between the fixed sheave 7a and the movable sheave 7b is widened so that the running radius of the driving belt 6 is narrowed.

Therefore, in case of thus increasing the input speed of the belt type-continuously variable transmission 3, the driving belt 6 is contacted with the radially inner region of the belt groove of the driven pulley 7. In this situation, the movable sheave 7b pushes the driving belt 6 transmitting the torque onto the fixed sheave 7a by a pushing force possible to prevent a slippage of the driving belt 6 in the circumferential direction. On the other hand, in the drive pulley 4, the movable sheave 4b pushes the driving belt 6 toward the fixed sheave 7a by a pushing force possible to prevent the driving belt 6 in the drive pulley 4 from being changed in its running radius by the pushing force clamping the driving belt 6 in the driven pulley 7.

In case the vehicle is decelerated or stopped abruptly under the situation in which the input speed of the belt type-continuously variable transmission 3 is thus being increased, the speed change ratio of the belt type-continuously variable transmission 3 is increased to prepare for accelerating the decelerated vehicle or starting the stopped vehicle. That is, a downshifting is carried out. Specifically, in the drive pulley 4, the hydraulic pressure being applied to the hydraulic chamber 4c for pushing the movable sheave 4b is reduced to withdraw the movable sheave 4b from the fixed sheave 4a. As a result, the belt groove of the drive pulley 4 is widened by the driving belt 6 moving from the radially outer region toward the radially inner region of the belt groove of the drive pulley 4, and the running radius of the driving belt 6 is thereby reduced in the drive pulley 4.

To the contrary, in the driven pulley 7, the hydraulic pressure being applied to the hydraulic chamber 7c is increased to push the movable sheave 7b toward the fixed sheave 7a. As a result, the belt groove of the driven pulley 7 is narrowed thereby pushing the driving belt 6 in the belt groove from the radially inner region toward the radially outer region of the belt groove to increase running radius of the driving belt 6. In this situation, the driving belt 6 entering into the radially outer region of the belt groove slides radially outwardly in the belt groove. Therefore, a speed changing rate in the direction to increase the speed change ratio is increased. That is, in case the driving belt 6 enters into the radially outer region of the driven pulley 7, the driving belt 6 is allowed to slide radially outwardly therein even if the vehicle is decelerated or stopped abruptly and the driven pulley 7 is thereby halted or rotated at low speed. Therefore, the speed change ratio of the belt type-continuously variable transmission 3 can be increased promptly to the ratio sufficient to restart or to accelerate the vehicle. In addition, in case the driving belt 6 thus slides radially outwardly in the belt groove of the driven pulley 7, the movable sheave 7b is pushed toward the fixed sheave 7a according to such displacement of the driving belt 6.

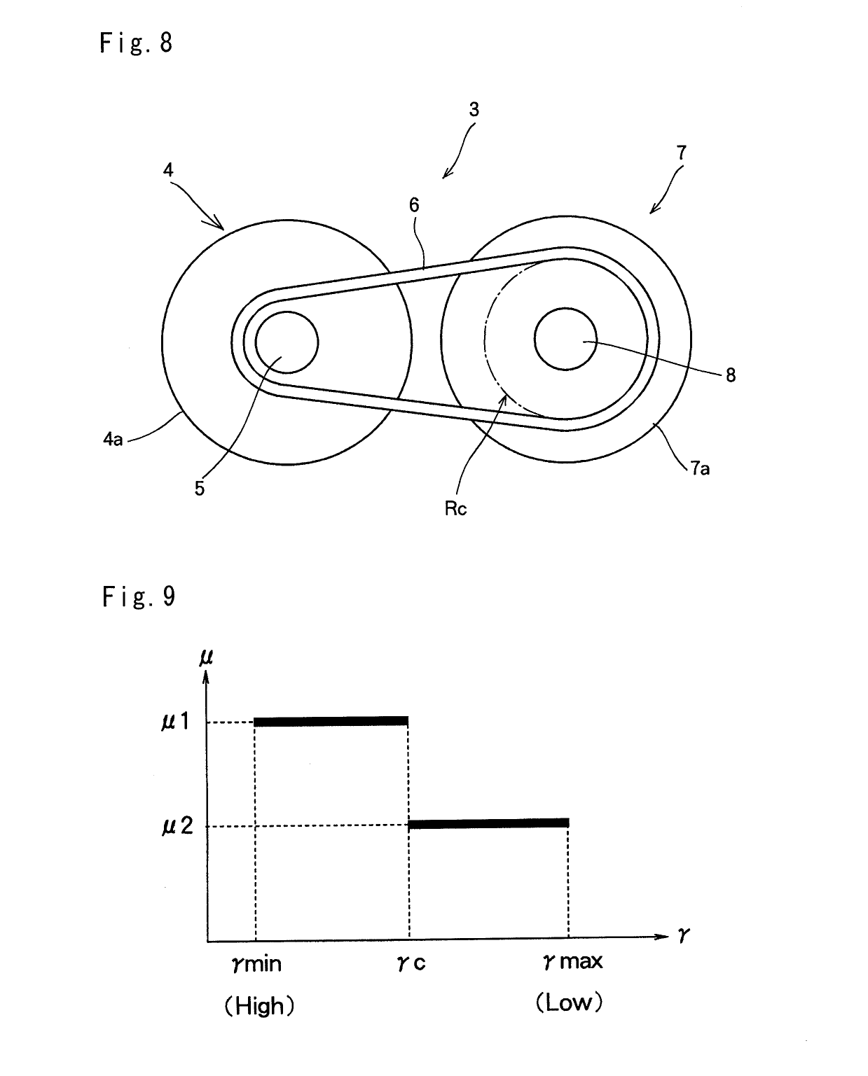

FIG. 8 is a view showing the belt type-continuously variable transmission 3 increasing the speed change ratio thereof. In case of increasing the speed change ratio of the belt type-continuously variable transmission 3 as shown in FIG. 8, that is, in case of decreasing the input seed of the belt-type continuously variable transmission 3, the driving belt 3 is situated in the radially outer region of the belt groove of the driven pulley 7. In this situation, the movable sheave 7b pushes the driving belt 6 in the belt groove of the driven pulley 7 by a pushing force which does not to cause a slippage of the driving belt 6 in the circumferential direction even if the driving belt 6 transmits the torque required to start the vehicle.

FIG. 9 is a graph schematically showing a relation between the speed change ratio of the continuously variable transmission 3 and the friction coefficient of the driven pulley 7. As described, the driving belt 6 is contacted to the radially inner region of the belt groove of the driven pulley 7 in case the input speed of the belt-type continuously variable transmission 3 is being increased, and as shown in FIG. 9, the friction coefficient μ1 of the radially inner region of the belt groove of the driven pulley 7 is relatively large. As also described, the driving belt 6 is contacted to the radially outer region of the belt groove of the driven pulley 7 in case the input speed of the belt-type continuously variable transmission 3 is being decreased, and as also shown in FIG. 9, the friction coefficient μ2 of the radially inner region of the belt groove of the driven pulley 7 is relatively small. Therefore, the control system according to the present invention is adapted to increase the pushing force for pushing the movable sheave 7b by the hydraulic control unit 9, in case of transmitting the torque under the situation in which the driving belt 6 is contacted to the radially outer region of the belt groove of the driven pulley 7. For example, in case of accelerating the vehicle or increasing the torque of the vehicle by increasing the speed change ratio by widening the running radius of the driving belt 6 in the driven pulley 7 from the radially inner region to the radially outer region of the belt groove across the border Rc, the hydraulic control unit 9 increases the hydraulic pressure pushing the movable sheave 7b thereby preventing an occurrence of slippage of the driving belt 6. However, in case of thus increasing the pushing force for pushing the movable sheave 7b, extra energy is required to increase the pushing force.

Thus, the control system of the present invention is configured to prevent an occurrence of circumferential slippage of the driving belt 6 in the driven pulley 7 by increasing the hydraulic pressure applied to the driven shave 7b, in case the driving belt 6 is situated in the radially outer region of the belt groove of the driven pulley 7. In addition, in order to prevent deterioration in fuel economy under the economy mode, the control system of the present invention is configured to increase frequency of carrying out a speed change operation within the radially inner region of the belt groove of the driven pulley 7, or to carry out a speed change operation only within the radially inner region of the belt groove of the driven pulley 7, in case the economy mode is selected.

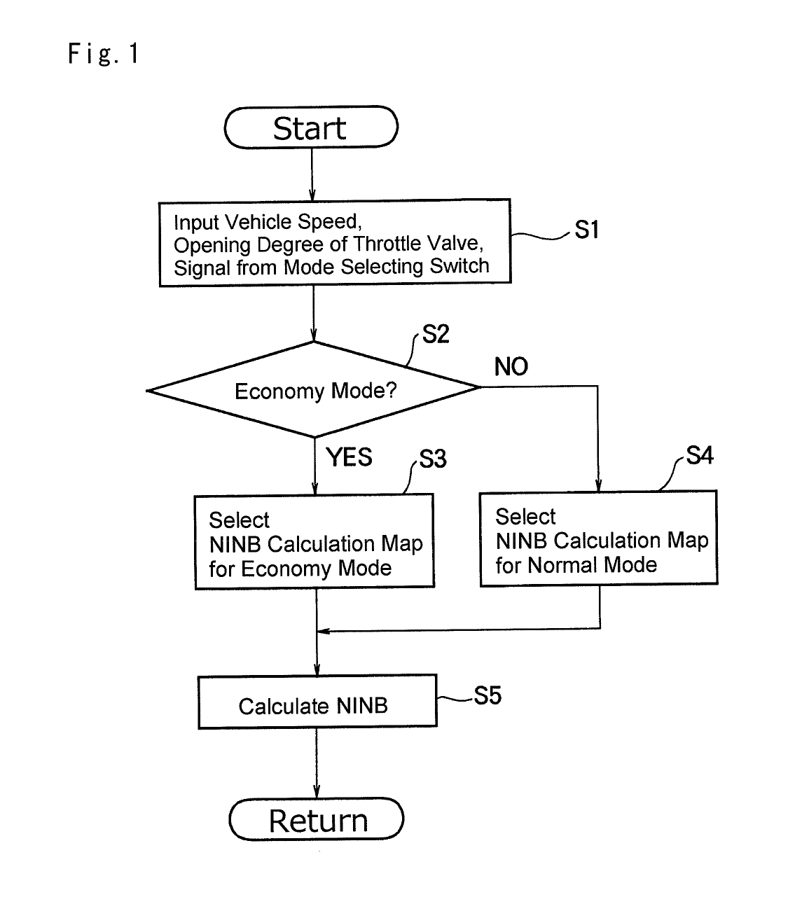

FIG. 1 is a flowchart explaining a control example of the belt-type continuously variable transmission 3 to be carried out by the control system of the present invention. First of all, a current speed of the vehicle, an opening degree of the throttle valve or an accelerator, a signal from the mode selecting switch, and information from the navigation system such as a current location, road information including a road gradient and so on are inputted (at step S1). Here, an electronic throttle valve whose opening degree is controlled by an actuator actuated electrically according to the opening degree of the accelerator may be used as the throttle valve. In this case, the opening degree of the electronic throttle valve according to the opening degree of the accelerator is inputted. Then, it is judged whether or not the economy mode is selected by the mode selecting switch (at step S2). For example, the judgment at step S2 can be made on the basis of the signal inputted from the mode selecting switch at step S1.

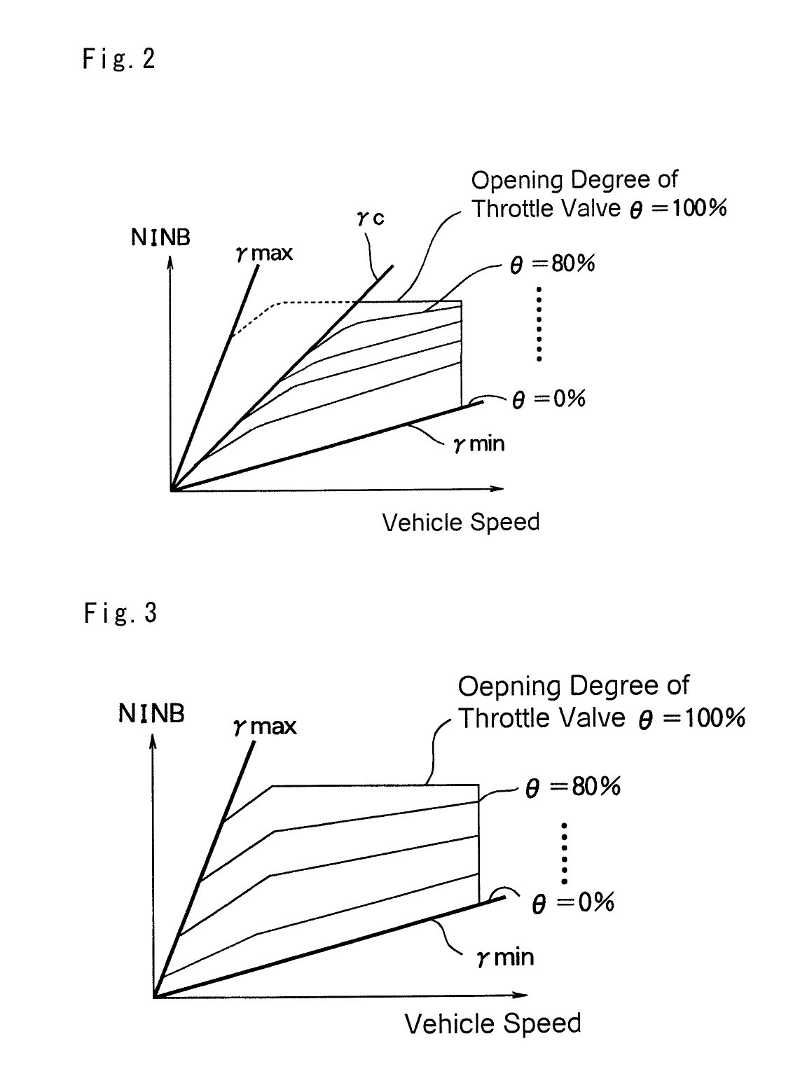

In case the economy mode is selected so that the answer of step S2 is YES, a map shown in FIG. 2 for calculating a theoretical input speed (NINB) under the economy mode is selected (at step S3). Specifically, the map shown in FIG. 2 is a speed change map for calculating the theoretical input speed (NINB) to the belt-type continuously variable transmission 3 on the basis of the vehicle speed and the opening degree of the throttle valve, and as shown in FIG. 2, the speed change ratio of the belt-type continuously variable transmission 3 is restricted within the region between the border ratio γc and the minimum ratio y min in case the economy mode is selected. In addition, the vehicle speed and the opening degree of the throttle valve are changed momentarily, and the theoretical input speed (NINB) is calculated taking into consideration an inevitable delay in changing the vehicle speed with respect to a change in the opening degree of the throttle valve. Therefore, the theoretical input speed (NINB) is varied according to the temporal change of the vehicle speed and the opening degree of the throttle valve.

To the contrary, in case the economy mode is not selected, for example, in case the normal mode is selected by the mode setting switch so that the answer of step S2 is NO, a map shown in FIG. 3 for calculating the theoretical input speed (NINB) under the normal mode is selected (at step S4). Alternatively, in case the power mode is selected so that the answer of step S2 is NO, a (not shown) map for calculating the theoretical input speed (NINB) under the power mode is selected (at step S4). Thus, the map for calculating the theoretical input speed (NINB) is switched at step S2 depending on the selected driving mode. As described, in case the map shown in FIG. 2 is selected, the speed change ratio of the belt-type continuously variable transmission 3 is restricted within the region between the border ratio y c and the minimum ratio y min. That is, in case the map shown in FIG. 2 is selected, the speed change ratio to be set by the belt-type continuously variable transmission 3 is smaller than that of the case in which the map for normal mode is selected. In this case, therefore, the theoretical input speed (NINB) to the continuously variable transmission 3 is to be calculated on the basis of the relatively smaller speed change ratio.

Then, the theoretical input speed (NINB) is calculated on the basis of the map selected at step S3 or S4 (at step S5). Specifically, in case the map for economy mode shown in FIG. 2 is selected at step S3, the theoretical input speed (NINB) is calculated on the basis of the current vehicle speed and the opening degree of the throttle valve with reference to the map shown in FIG. 2. As described, in case the map for the economy mode shown in FIG. 2 is selected, the speed change ratio to be set is restricted within the region between the border ratio y c and the minimum ratio y min. In this case, therefore, the speed change ratio of the belt-type continuously variable transmission 3 is set using only the inner circumferential region of the belt groove of the driven pulley 7. Meanwhile, in case the map for the normal mode shown in FIG. 3 is selected, the theoretical input speed (NINB) is calculated on the basis of the current vehicle speed and the opening degree of the throttle valve with reference to the map shown in FIG. 3. In this case, the speed change operation is to be carried out by the normal speed change control.

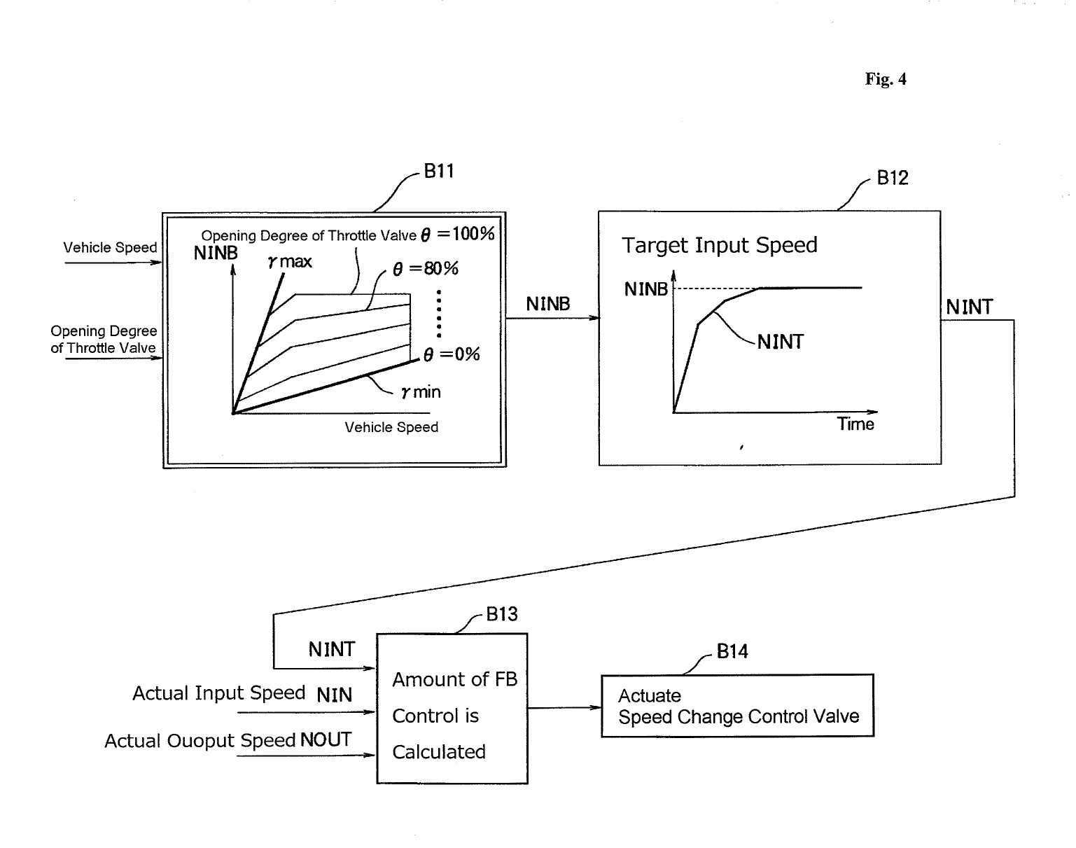

Then, the routine is once ended and the speed change operation is carried out on the basis of the theoretical input speed (NINB) thus calculated. FIG. 4 is a block diagram briefly explaining a procedure of the speed change control. First of all, the theoretical input speed (NINB) is calculated as explained with reference to FIG. 1 (at block B11). Then, a target input speed (NINT) is calculated on the basis of the calculated theoretical input speed (NINB) with reference to a map for calculating the target input speed (NINT) (at block B 12). For this purpose, the map shown in block B12 of FIG. 4 is used to calculate the target input speed (NINT). Specifically, the target input speed (NINT) is a target speed of the pulley shaft 5 of the drive pulley 4 to achieve the theoretical input speed (NINB). For this purpose, the target input speed (NINT) is set with respect to elapsed time from a commencement of the speed change until the speed of the pulley shaft 5 reaches the theoretical input speed (NINB).

Then, an amount feedback control is calculated on the basis of the target input speed (NINT), an actual current speed of the pulley shaft 5, i.e., an actual input speed (NIN) and an actual current speed of the pulley shaft 8, i.e., an actual output speed (NOUT) (at block B13). Specifically, in order to achieve the target input speed (NINT) by the pulley shaft 5, a deviation between the current actual input speed (NIN) and the target input speed (NINT) is calculated at block B13. In addition, an actual speed change ratio is calculated on the basis of the actual input speed (NIN) and the actual output speed (NOUT), and the hydraulic pressure required to be applied to the hydraulic chambers 4c and 7c to change the actual input speed (NIN) of the pulley shaft 5 to the target input speed (NINT) is calculated on the basis of the calculated deviation and the actual speed change ratio at block B13. Then, the speed change operation is carried out on the basis of the feedback control amount thus calculated by actuating a not shown speed change control valve (at block B14). Specifically, the speed of the actual input speed (NIN) of the pulley shaft 5 is changed to the target input speed (NINT) by changing the speed change ratio while applying the hydraulic pressure thus calculated to the hydraulic chambers 4c and 7c from the hydraulic control unit 9.

As explained, according to the belt-type continuously variable transmission 3 thus structured, the friction coefficient μ2 of the radially outer region of the belt groove of the driven pulley 7 is reduced to be smaller than the friction coefficient μ1 of the radially inner region thereby allowing the driving belt 6 to slide thereon. Therefore, the driving belt 6 can be moved in the radial direction while sliding on the tapered faces of the belt groove by changing the width of the belt groove of the driven pulley 7, even in case the rotational speed of the driven pulley 7 is low or in case the driven pulley 7 is not rotated. That is, a sliding speed change can be carried out. For this reason, the driving belt 6 can be returned to the radially outer region of the driven pulley 7 smoothly even in case of decelerating or stopping the vehicle abruptly. In addition, according to the control thus has been explained with reference to FIGS. 1 to 4, the speed change operation is carried out mainly or only within the inner circumferential region of the belt groove of the driven pulley 7 in case the economy mode is selected. Therefore, the pushing force for pushing the movable sheave 7b can be reduced while improving the power transmission efficiency. For this reason, the fuel economy of the engine 1 can be improved, in other words, the fuel economy of the engine 1 can be prevented from being degraded.

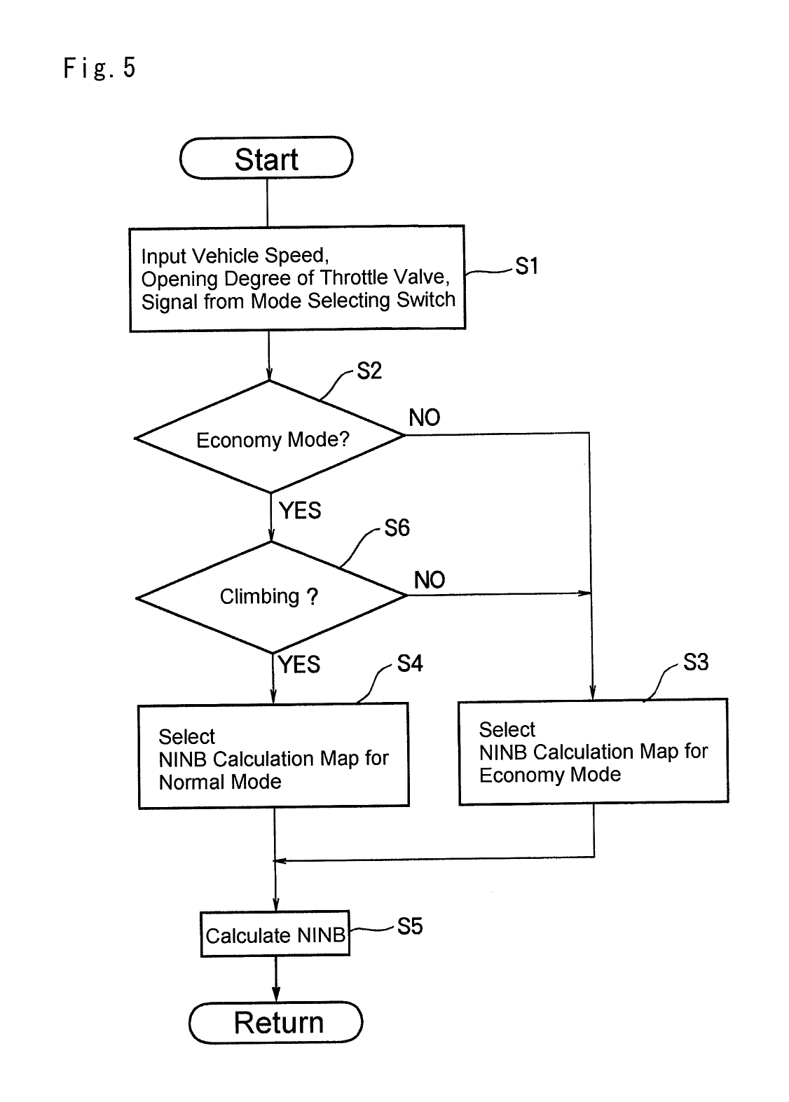

Meanwhile, the driving force required for the vehicle is varied depending on a driving condition such as traffic, road gradient etc. Therefore, the driving force and the acceleration of the vehicle have to be changed depending on the driving condition. FIG. 5 is a flowchart explaining control example for that purpose. The control example shown in FIG. 5 is an alternative of the above-explained control example shown in FIG. 1, therefore, an explanation for the control steps of the control shown in FIG. 5 in common with those of the control shown in FIG. 1 will be omitted by allotting common reference numerals.

According to the control shown in FIG. 5, in case the economy mode is selected so that the answer of step S2 is YES, the routine advances to step S6 to judge whether or not the vehicle is climbing a hill. As described, the road information can be obtained from the navigation system so that the judgment at step S6 can be made on the basis of the information from the navigation system. That is, at step S6, it is judged whether or not the torque of the engine 1 is demanded to be increased, or the driving force or the acceleration of the vehicle is demanded to be increased. For this purpose, the judgment at step S6 can also be made by judging whether or not the drive demand is larger than a threshold. In case the vehicle is climbing a hill so that the answer of step S6 is YES, in other words, in case the driving force or the acceleration is demanded to be increased, the routine advances to step S4 and the map for normal mode or power mode is selected. To the contrary, in case the vehicle is not climbing a hill so that the answer of step S6 is NO, in other words, in case the driving force or the acceleration is not demanded to be increased, the routine advances to step S3 and the map for economy mode is selected.

Thus, according to the control example shown in FIG. 5, in case the vehicle running is climbing a hill and the driving force is therefore demanded to be increased, the driving mode is shifted from the economy mode to the power mode or the normal mode to increase the driving force and the acceleration. For this reason, hill-climbing performance of the vehicle can be improved.

Here will be briefly explained a relation between the examples thus far explained and the present invention. The functional means for carrying out the control of step S2 corresponds to the driving mode judging means of the present invention, the functional means for carrying out the controls of steps S3 to S5 correspond to the speed change region setting means and the inhibiting means of the present invention, and the functional means for carrying out the control of step S6 corresponds to the torque demand judging means and the hill climbing judging mans of the present invention.

1. A control system for a belt-type continuously variable transmission, which comprises a drive pulley and a driven pulley, each of which is formed by a fixed sheave integrated with a rotary shaft and a movable sheave allowed to move in an axial direction; and
a driving belt interposed between tapered faces of the fixed sheave and the movable sheaves being opposed to each other; and
which is configured to change a torque of a prime mover for driving a vehicle by varying a speed change ratio continuously while moving the movable sheave in an axial direction;
wherein the control system is configured to select a drive mode of the vehicle from a plurality of drive modes including an energy saving mode for reducing an energy consumption of the prime mover, and to control a speed change operation on the basis of any of the selected drive mode;
a friction coefficient in a radially outer region of the tapered face of the driven pulley is smaller than that in a radially inner region of the tapered face of the driven pulley; and
the control system comprises a speed change region setting means that increases frequency of carrying out a speed change operation within said radially inner region in case the energy saving mode is selected.

2. The control system for a belt-type continuously variable transmission as claimed in claim 1, wherein:
the speed change region setting means includes an inhibiting means that increases frequency of carrying out a speed change operation within said radially inner region, by inhibiting a speed change operation in said radially outer region.

3. The control system for a belt-type continuously variable transmission as claimed in claim 1, wherein:
the drive mode includes a normal mode for a case of running the vehicle normally; and
the speed change region setting means includes a means that increases frequency of carrying out a speed change operation within said radially inner region in case the energy saving mode is selected, by restricting the region of the tapered face used to change the speed change ratio within the region used to set the speed change ratio smaller than that set in the region used to change the speed change ratio under the normal mode.

4. The control system for a belt-type continuously variable transmission as claimed in claim 1, wherein:
the speed change region setting means includes a means that carries out the speed change operation only within said radially inner region.

5. The control system for a belt-type continuously variable transmission as claimed in claim 1, further comprising:
a drive mode judging means that judges whether or not the energy saving mode is selected; and
a torque demand judging means that judges whether or not the prime mover is demanded to increase the torque thereof; and
wherein the drive mode judging means includes a means adapted to judge that the energy saving mode is not selected even if the energy saving mode is selected, in case the drive mode judging means judges that the energy saving mode is selected, and the torque demand judging means judges that the prime mover is demanded to increase the torque thereof.

6. The control system for a belt-type continuously variable transmission as claimed in claim 5, wherein:
the torque demand judging means includes a means that judges whether or not the prime mover is demanded to increase the torque thereof, on the basis of a fact that a drive demand of the vehicle is increased, or a fact that the vehicle is climbing a hill.

7. The control system for a belt-type continuously variable transmission as claimed in claim 1, wherein:
said radially outer region includes a region where the driving belt is situated to set a speed change ratio possible to start the stopping vehicle.

8. The control system for a belt-type continuously variable transmission as claimed in claim 1, wherein:
the driving belt is a nonmetallic combined belt comprising a plurality of metal pieces withstanding a pressure from the tapered faces of the sheaves forming a belt groove, and a resin band fastening the metal pieces in a circular manner.
